(19) United States
(12) Patent Application Publication
(10) Pub. No.: US 2015/0202560 A1
(43) Pub. Date: Jul. 23, 2015

(54) FILTER BAG ASSEMBLY WITH RIGID MESH FOR REDUCING FILTER PRESSURE LOSS

(71) Applicant: BHA Altair, LLC, Franklin, TN (US)

(72) Inventors: Etienne Rene Jarrier, Reading (GB); James Warren Pemrick, Troy, NY (US)

(21) Appl. No.: 14/160,888

(22) Filed: Jan. 22, 2014

(51) Int. Cl. B01D 46/02

(52) U.S. Cl. CPC B01D 46/023

(57) ABSTRACT

A filter bag assembly includes a first filter bag having at least two sidewalls of filter material extending from an open end to a closed end of the first filter bag at which the sidewalls connect to close the first filter bag. Two of the sidewalls of filter material are opposed to each other across the first filter bag and spaced from each other at the open end of the first filter bag. The two sidewalls are configured to form a tapered pocket, and the first filter bag includes a plurality of tapered pockets. A substantially rigid mesh is in contact with the first filter bag. The mesh is configured in a substantially V-shape and located near the open end of the first filter bag. The mesh is configured to maintain a shape of the tapered pockets and reduce filter pressure loss during use of the filter bag assembly.

### BACKGROUND OF THE INVENTION

The subject matter disclosed herein relates to filters, and more particularly to reinforced filters that reduce pressure loss.

A gas turbine engine combusts a fuel-air mixture to generate hot combustion gases, which drive rotation of turbine blades in a turbine section. The gas turbine engine may be used to drive an electrical generator or another load. The gas turbine engine intakes air through an air filter, which removes particulates to protect internal components of the gas turbine engine. Unfortunately, existing air filters may be inadequate for certain environmental conditions, such as heavy fog, dust/sand storms, and other harsh conditions. An inadequate air filter may cause operational problems for the turbine, such as, unforeseen shutdown or increased performance degradation. Thus, under such harsh conditions, the installed air filter would require replacement with another more suitable air filter, thereby resulting in waste of the installed air filter.

Some existing air filters are designed with adjacent pleats or pockets, and during use these pockets can contact each other. When the pockets contact each other pressure loss is increased. This is due to the fact that less filter media is available for air passage. Shelves that extend from one pocket surface directly to an opposing pocket surface have been used to help support the pockets, but this approach suffers from the disadvantage that pre-filters cannot be used or nested with the primary filter.

### BRIEF DESCRIPTION OF THE INVENTION

In an aspect of the present invention, a filter bag assembly includes a first filter bag that includes at least two sidewalls of filter material extending from an open end of the first filter bag to a closed end of the first filter bag at which the sidewalls connect to close the first filter bag. Two of the sidewalls of filter material are opposed to each other across the first filter bag and spaced from each other at the open end of the first filter bag. The at least two sidewalls are configured to form a tapered pocket, and the first filter bag includes a plurality of tapered pockets. A substantially rigid mesh is in contact with the first filter bag. The substantially rigid mesh is configured in a substantially V-shape and located near the open end of the first filter bag. The substantially rigid mesh is configured to maintain a shape of the tapered pockets and reduce filter pressure loss during use of the filter bag assembly.

In another aspect of the present invention, a filter bag assembly has a primary filter bag that includes at least two sidewalls of filter material extending from an open end of the primary filter bag to a closed end of the primary filter bag at which the sidewalls connect to close the primary filter bag. Two of the sidewalls of filter material are opposed to each other across the primary filter bag and are spaced from each other at the open end of the primary filter bag. Two sidewalls are configured to form a tapered pocket, and the primary filter bag includes a plurality of tapered pockets. A substantially rigid mesh is in contact with the primary filter bag. The substantially rigid mesh is configured in a substantially V-shape and located near the open end of the primary filter bag. The substantially rigid mesh is configured to avoid contact between adjacent tapered pockets and reduce filter pressure loss during use of the filter bag assembly.

### BRIEF DESCRIPTION OF THE DRAWINGS

FIG. 1 illustrates a perspective view of an embodiment of a power generation facility with turbine air filters;

FIG. 2 illustrates a perspective view of an embodiment of the filter frame of FIG. 1 with turbine air filters;

FIG. 3 illustrates a perspective view of one known filter;

FIG. 4 illustrates a perspective view of the filter shown in FIG. 3 during operation;

FIG. 5 illustrates a perspective view of one known filter that uses shelves to reduce the pocket expansion problem;

FIG. 6 illustrates a schematic view of a filter bag, according to an aspect of the present invention;

FIG. 7 illustrates a perspective view of a filter bag assembly having a first filter bag and a second filter bag; and

FIG. 8 illustrates a schematic view of a filter bag, according to an aspect of the present invention.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developer's specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a”, “an” and “the” are intended to mean that there are one or more of the elements. The terms “comprising,” “including,” and “having” are intended to be inclusive and mean that there may be additional elements other than the listed elements.

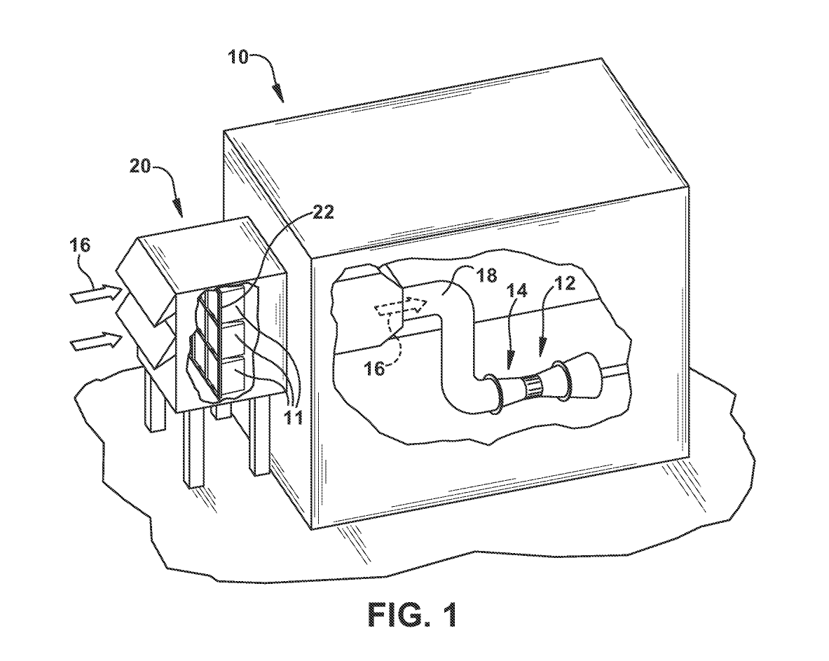

FIG. 1 is a perspective view of an embodiment of a power generation facility 10 that uses air filters 11. The power generation facility 10 includes a gas turbine engine 12 that generates electrical power. The turbine engine 12 includes an air compressor 14 that draws intake air 16 into the turbine engine 12 from the outdoors through air ducts 18. As the intake air 16 enters the facility, it first passes through a filter house 20. Inside the filter house 20, an array of filters 11, held by one or more filter frames 22, filter the intake air 16 to remove contaminants such as dust, dirt, moisture, salt, carbon and any other contaminants that may tend to reduce the performance of the turbine 12. The primary filters described herein may be the final filtration stage but, the filter house 20 could also include weather hoods, mist eliminators, vanes, pre-filters, and other filtering devices. The filter house 20 may be several stories high, and may house up to several hundred filters 11, which may be held by several filter frames 22.

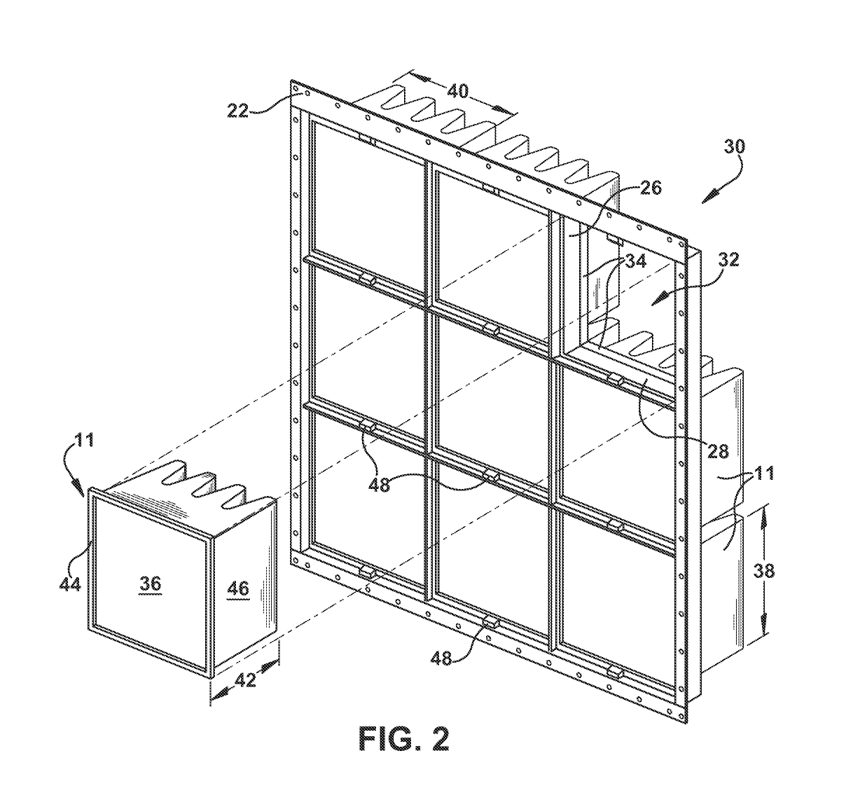

FIG. 2 is a perspective view illustrating an embodiment of the filter frame 22 of FIG. 1. As shown in FIG. 2, the filter frame 22 includes a set of vertical support panels 26 and horizontal support panels 28 that define filter cells 30. The vertical support panels 26 and horizontal support panels 28 serve, in part, as dividers between the filter cells 30, each of which holds a single air filter 11. Each filter cell 30 may include an aperture 32 through which the filter 11 may pass, and a sealing face 34 against which the filter 11 may be pressed to block air from flowing around the filter 11. The filter 11 may include a filter body 46 that passes through the aperture 32 and a sealing flange 44 disposed about the rim of the outward face 36 of the filter body 46. The sealing flange 44 may be configured to fit inside the filter cell 30 and may be pressed against the sealing face 34. A gasket may be disposed between the sealing face 34 and the filter flange 44 to provide an airtight seal between the filter 11 and the sealing face 34.

The filters 11 may be any suitable type, such as bag filters or mini-pleat filters for example. Additionally, the filters 11 may also be any suitable size. For example, in some embodiments, the filter height 38 and width 40 may be approximate 600 mm, the filter depth 42 may be approximately 400 to 800 millimeters, and each filter 11 may weigh between about 2 to about 15 kilograms. Additionally, in some embodiments, the filter cells 30 and/or the filter frame 22 may provide suitable drainage for moisture, which may collect on the outside of the filter 11. Also included in the filter frame 22 are several fasteners or latches 48, which hold the filters 11 within the frame and provide sufficient compression to the sealing flange 44 to provide the airtight seal between the filter 11 and the sealing face 34.

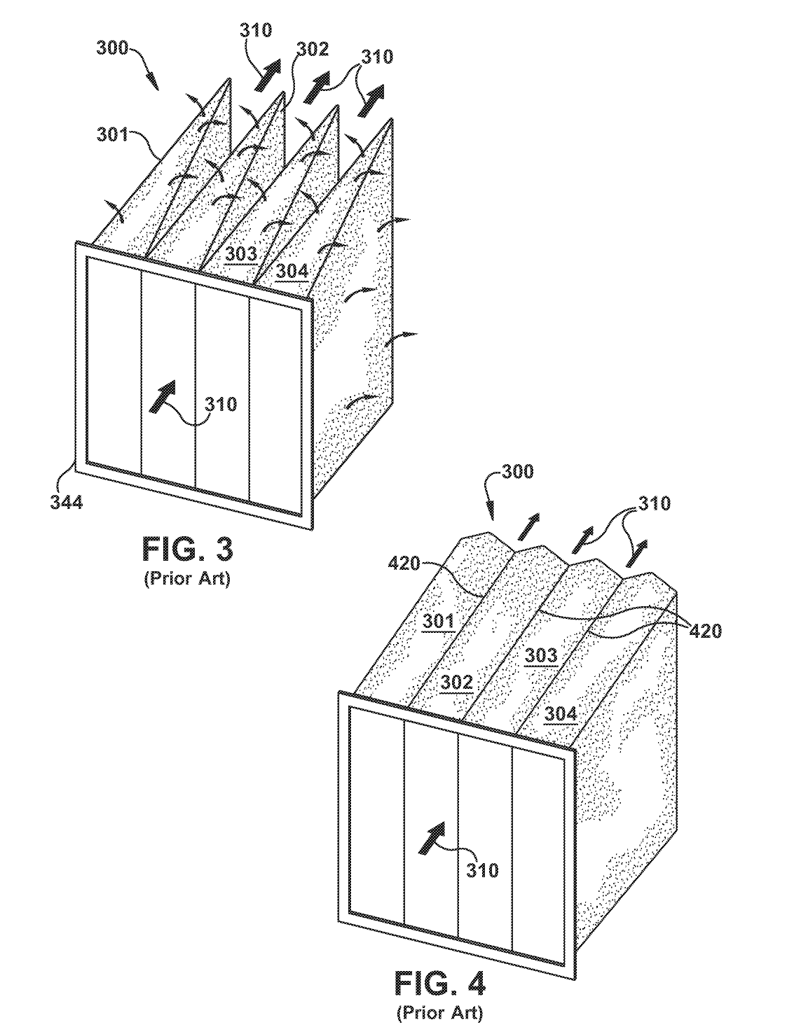

FIG. 3 illustrates a perspective view of one known filter 300. The filter 300 includes a plurality of tapered pockets 301, 302, 303 and 304. In theory, air flow 310 travels from the flange 344 to the far end of the tapered pockets. If the tapered pockets maintain their tapered shape, then air exits over substantially all downstream surfaces of the tapered pockets, as indicated by the curved arrows. Unfortunately, the tapered pockets do not always maintain their tapered shape during use due to the forces of the airflow.

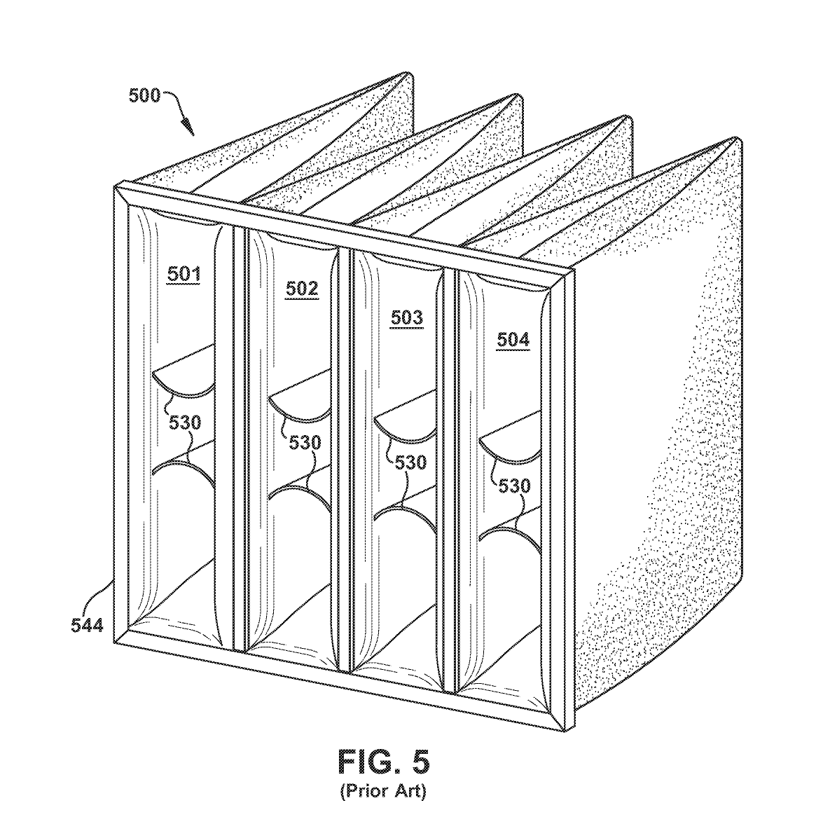

FIG. 4 illustrates a perspective view of the filter 300 during operation in some conditions. The tapered pockets 301, 302, 303 and 304 expanded due to airflow pressure, and have now become parallel pockets with a much smaller outlet area. Airflow no longer exits from the side surfaces of the pockets 301, 302, 303 and 304, but rather exits only from the very end surfaces of the pockets. The interior side surfaces 420 have ceased to actually filter the air 310, because the air pressure is equal on both sides of surfaces 420. This results in increased filter 300 pressure loss and reduced gas turbine 12 efficiency, as more energy is required to pull air through the filter 300, and the filter 300 becomes dirty more quickly as only a small portion of the filter 300 is actually being used to filter the air.

FIG. 5 illustrates a perspective view of one known filter 500 that uses shelves 530 to reduce the pocket expansion problem. Filter 500 is similar to filter 300 in that flange 544 is used to support a plurality of tapered pockets 501, 502, 503 and 504. However, shelves 530 have been attached to the interior surfaces of the tapered pockets, and each shelf 530 has a triangular shape, that is wide near the open end of filter 500 and progressively narrows as it extends towards the closed portion of each tapered pocket. The shelves 530 do help to reduce pocket expansion, but these only work in very localized regions. Non-supported regions (i.e., those regions not in contact with shelves 530) of the filter media can still expand during use. However, the biggest drawback to the shelves 530 is that a pre-filter (which is similar in size and shape to the main filter) cannot be nested inside filter 500, because the primary filter shelves block the inside of the pre-filter tapered pockets.

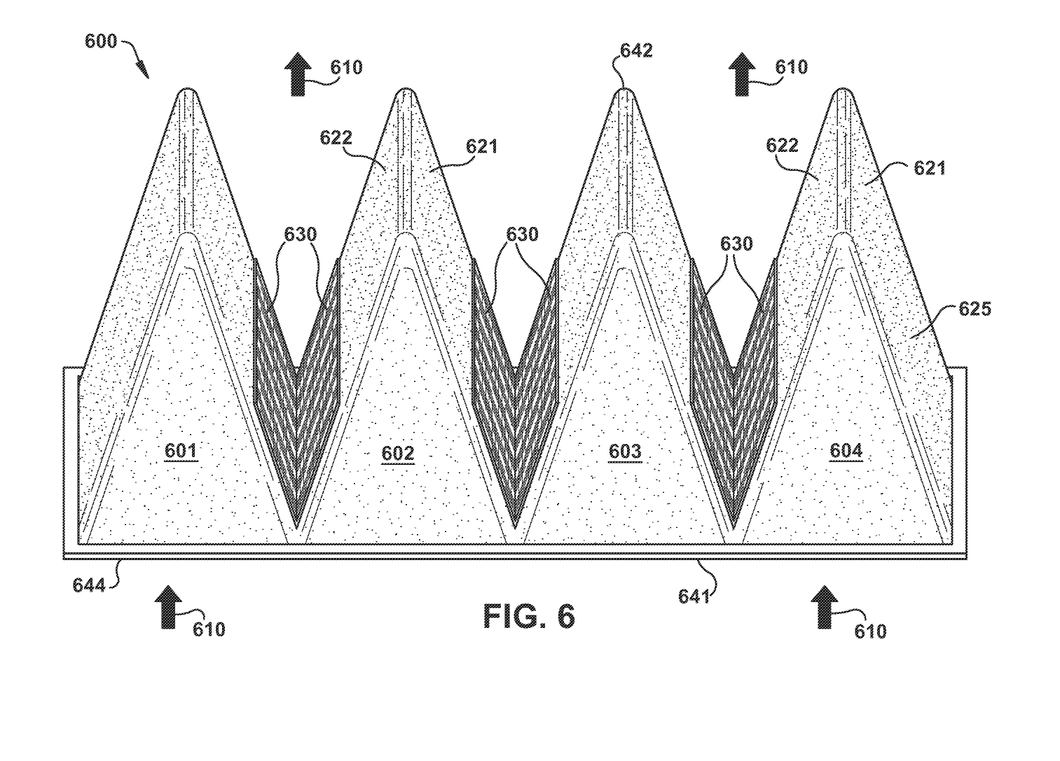

FIG. 6 illustrates a schematic view of a filter bag 600, according to an aspect of the present invention. The filter bag 600 may be viewed as a first filter bag that includes at least two sidewalls 621 and 622 of filter material 625 extending from an open end 641 of the first filter bag 600 to a closed end 642 of the first filter bag 600. At the closed end 642, the sidewalls 621, 622 connect to close the first filter bag 600. Two of the sidewalls 621, 622 of filter material are generally opposed to each other across the first filter bag and spaced from each other at the open end 641. In this manner, the sidewalls 621, 622 are configured to form a tapered pocket 604, and the filter bag 600 preferably includes a plurality of tapered pockets 601, 602, 603, 604. Air flow 610 flows generally from the open 641 through the filter media 625 and exits the closed end 642.

A substantially rigid mesh 630 is placed in contact with the filter bag 600. The mesh 630 is configured in a substantially V-shape and located near the open end 641 of the filter bag 600. The rigid mesh 630 is configured to maintain a tapered shape of the tapered pockets 601-604 and reduce filter pressure loss during use of the filter bag assembly. The mesh 630 may be comprised of a steel or galvanized steel wire mesh having openings of about ¼inch to about 1 inch in size. The wire may have a diameter from about 0.06 inches to about 0.25 inches and the mesh 630 may have an open area of about 75% to about 95%. It is to be understood that other materials (e.g., metal, metal alloys, plastics, natural materials, etc.) may be employed to fabricate the mesh 630, and that wire and open areas of other sizes resulting in different percentages of open areas may be sued without departing from the spirit and scope of the present invention. As one example only, a plastic mesh may have “wire” that is rectangular in profile (or cross-section). An important feature is that an open area of at least 50% or greater is used to reduce filter pressure loss during use of the filter bag. Open areas of less than 50% can be used, but will result in greater filter pressure loss when compared with more open area meshes. In addition, the mesh should be designed to have enough rigidity to maintain the substantially V-shape during use of the filter 600, and in so doing the wire diameter should be chosen accordingly.

The rigid mesh 630 is also configured to cover only a portion of the tapered pockets, with a remainder of the tapered pockets having no rigid mesh. This feature will further decrease filter pressure loss. For example, the rigid mesh 630 could be configured to cover about 50% of the tapered pockets (as shown in FIG. 6), or the mesh could cover about 25% to about 75% of the tapered pockets. The rigid mesh could cover about 100% of the tapered pockets, but this level of support is not required and the greater amount of mesh blockage may adversely affect pressure loss reduction.

The substantially rigid mesh 630 may be attached to outer portions (e.g., the downstream side) of adjacent tapered pockets (as shown), or the mesh 630 may be attached to the frame 644 of the filter bag 600. The mesh 630 could be held in place by friction as the filter media 625 will tend to partially envelope the wire mesh, or the mesh could be sewn, tied or adhesively connected to the filter media 625. The mesh 630 could also be tied or clamped to the frame 644, by any suitable fastener (e.g., clamps, wire or plastic ties, string or twine, etc.). In additional embodiments, the mesh 630 could be embedded within the filter media/material 625 or attached to the upstream side of the tapered pockets.

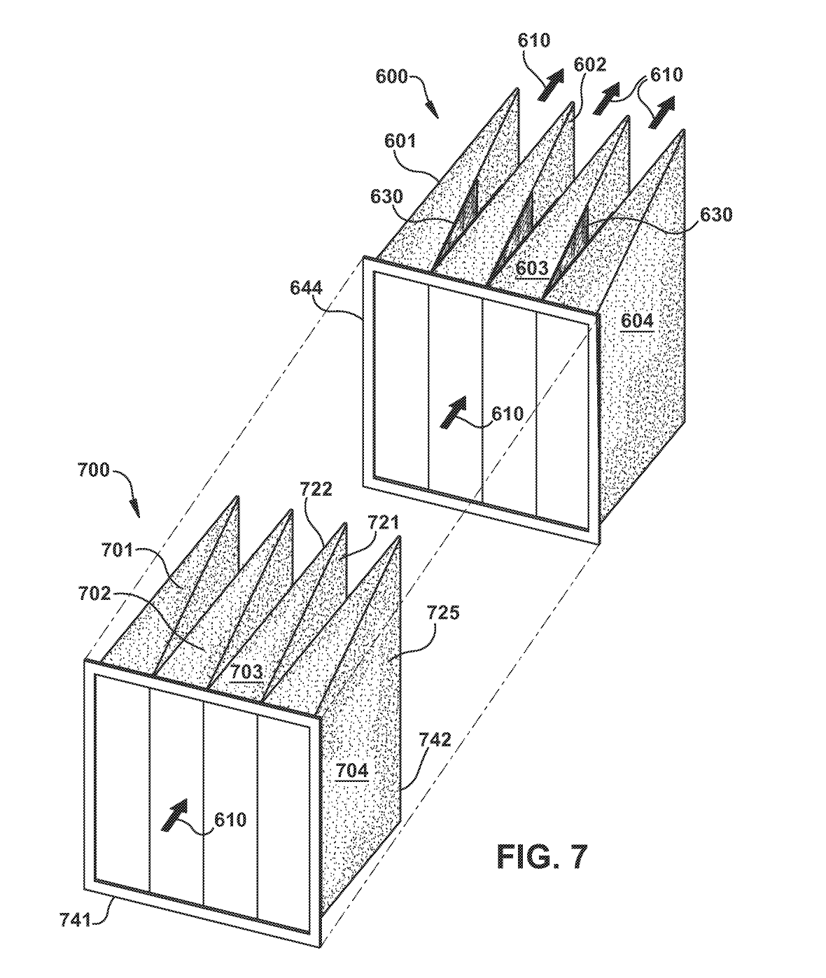

FIG. 7 illustrates a perspective view of a filter bag assembly having a first filter bag 600 and a second filter bag 700. The first filter bag 600 is a main (or primary) filter and may have an average filtration efficiency greater than or equal to 40% for a particle size of 0.4 microns (e.g., from a M5 to F9 class air filter, according to the EN779:2012 standard). The second filter bag 700, which may be configured as a pre-filter, may have an average filtration efficiency less than or equal to 50% for a particle size of 0.4 microns (e.g. from a G1 to M5 class air filter, according to the EN779:2012 standard). In the EN779:2012 standard, G1 to G4 filters are categorized as coarse filters, M5 to M6 filters are categorized as medium filters, and F7 to F9 filters are categorized as fine filters.

The second filter bag 700 (or pre-filter) includes at least two sidewalls 721, 722 of filter material 725 extending from an open end 741 of the second filter bag 700 to a closed end 742 of the second filter bag at which the sidewalls connect to close the second filter bag. The sidewalls are configured to form a tapered pocket, and the second filter bag includes a plurality of tapered pockets 701, 702, 703, 704. The second filter bag 700 (i.e., pre-filter) is configured to nest substantially within the first filter bag 600 (i.e., main filter). The pre-filter 700 can be removed and cleaned or exchanged with a new pre-filter without taking the gas turbine off-line, as the main filter 600 continues to filter the incoming air. The rigid mesh 630 maintains the desired tapered shape of both the main filter 600 and the pre-filter 700.

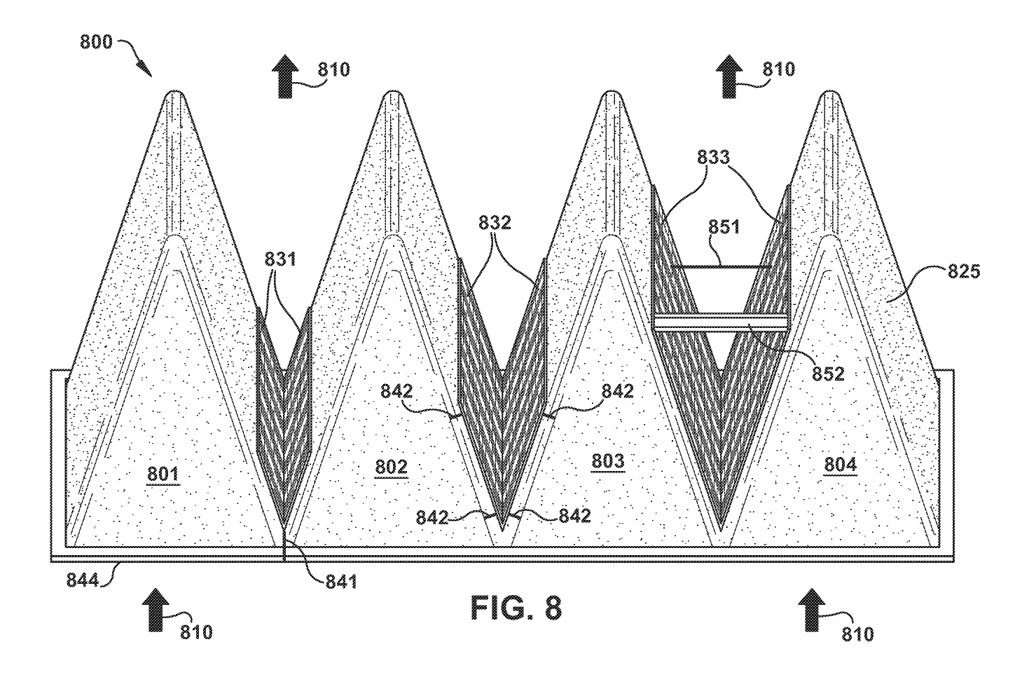

FIG. 8 illustrates a schematic view of a filter bag 800, according to an aspect of the present invention. The filter bag 800 includes a plurality of tapered pockets 801, 802, 803, 804 of filter media 825, and air flow 810 flows from the open end of the filter bag 800 to the closed end of the filter bag. The substantially rigid mesh 831 is configured to cover about 25% of the tapered pocket, and the remainder of the tapered pocket has no mesh. The mesh 831 is attached to the frame 844 by wire fasteners 841. The wire 841 could also be exchanged for a string, plastic zip-tie or clamp. The substantially rigid mesh 832 is configured to cover about 50% of the tapered pocket, and the remainder of the tapered pocket has no mesh. The mesh 832 is attached to the filter media 825 by wire fasteners 842. The wires 842 could also be exchanged for adhesive, string, plastic zip-ties or clamps. The substantially rigid mesh 833 is configured to cover about 70% of the tapered pocket, and the remainder of the tapered pocket has no mesh.

The mesh 833 may also include one or more mesh reinforcement member 851, 852 configured to support the substantially rigid mesh 833. The reinforcement member 851 or 852 is designed to be substantially rigid to support the mesh 833 so the mesh 833 will maintain its substantially V-shape. The reinforcement member 851 may be a rigid wire, rigid pole or any member capable of resisting collapse of the V-shaped mesh 833. The reinforcement member 852 may be rigid member having a cross-sectional I-shape for further strength and rigidity, and the member 852 could be comprised of metal, plastic, natural materials or mixtures thereof. Single or multiple reinforcement members could be used for each individual V-shaped mesh section.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A filter bag assembly comprising:
a first filter bag including a plurality of tapered pockets including first and second tapered pockets being adjacent to one another, each tapered pocket includes at least two sidewalls of filter material extending from an open end of the first filter bag to a closed end of the first filter bag at which the at least two sidewalls connect to close the tapered pocket, the at least two sidewalls of filter material including first and second sidewalls of filter media being opposed to each other across the first filter bag and being spaced from each other at the open end of the first filter bag, the first and second sidewalls defining a length between the open end and the closed end;
a substantially rigid mesh in contact with the first filter bag, the substantially rigid mesh configured in a substantially V-shape and located near the open end of the first filter bag, and the substantially rigid mesh is configured to maintain a shape of the tapered pockets and reduce filter pressure loss during use of the filter bag assembly, the substantially rigid mesh covering only a portion of one of the first and second sidewalls of the first tapered pocket and covering only a portion of one of the first and second sidewalls of the second tapered pocket with at least 50% of the length of the covered sidewalls between the open end and the closed end of the first and second tapered pockets being uncovered by the substantially rigid mesh.

2. (canceled)

3. The filter bag assembly of claim 1, wherein the substantially rigid mesh is configured to cover about 50% of the length of the first and second sidewalls.

4. The filter bag assembly of claim 1, wherein the substantially rigid mesh is configured to cover about 25% to about 50% of the length of the first and second sidewalls.

5. The filter bag assembly of claim 1, wherein the substantially rigid mesh is attached to outer portions of adjacent tapered pockets, or the substantially rigid mesh is attached to a frame of the first filter bag.

6. The filter bag assembly of claim 1, wherein the substantially rigid mesh is attached to upstream or downstream portions of adjacent tapered pockets, or the substantially rigid mesh is embedded within the filter material of the filter bag.

7. The filter bag assembly of claim 1, further comprising:
a second filter bag that includes at least two sidewalls of filter material extending from an open end of the second filter bag to a closed end of the second filter bag at which the sidewalls connect to close the second filter bag, the at least two sidewalls configured to form a tapered pocket, the second filter bag including a plurality of tapered pockets; and
wherein the second filter bag is configured to nest substantially within the first filter bag.

8. The filter bag assembly of claim 7, wherein the first filter bag is a main or primary filter and the second filter bag is a pre-filter.

9. The filter bag assembly of claim 8, wherein the main or primary filter has a filter efficiency greater than or equal to about 40%, and the pre-filter has a filter efficiency less than about 50%; and wherein the main or primary filter is a M5 to F9 class air filter, according to the EN779:2012 standard, and the pre-filter is a G1 to M5 class air filter, according to the EN779:2012 standard.

10. The filter bag assembly of claim 1, further comprising:
a mesh reinforcement member configured to support the substantially rigid mesh, so that the substantially rigid mesh will maintain its substantially V-shape.

11. The filter bag assembly of claim 10, wherein the mesh reinforcement member is comprised of at least one of:
a rigid wire, a rigid pole or a rigid member having a cross-sectional I-shape.

12. A filter bag assembly comprising:
a primary filter bag including a plurality of tapered pockets including first and second tapered pockets being adjacent to one another, each tapered pocket includes at least two sidewalls of filter material extending from an open end of the primary filter bag to a closed end of the primary filter bag at which the at least two sidewalls connect to close the primary filter bag, the at least two sidewalls of filter material including first and second sidewalls of filter media being opposed to each other across the primary filter bag and being spaced from each other at the open end of the primary filter bag, the first and second sidewalls defining a length between the open end and the closed end;
a substantially rigid mesh in contact with the primary filter bag, the substantially rigid mesh configured in a substantially V-shape and located near the open end of the primary filter bag, and the substantially rigid mesh is configured to avoid contact between the first and second tapered pockets and reduce filter pressure loss during use of the filter bag assembly, the substantially rigid mesh covering only a portion of one of the first and second sidewalls of the first tapered pocket and covering only a portion of one of the first and second sidewalls of the second tapered pocket with at least 50% of the length covered sidewalls between the open end and the closed end of the first and second tapered pockets being uncovered by the substantially rigid mesh.

13. (canceled)

14. The filter bag assembly of claim 12, wherein the substantially rigid mesh is configured to cover about 50% of the length of the tapered pockets.

15. The filter bag assembly of claim 12, wherein the substantially rigid mesh is configured to cover about 25% to about 50% of the length of the tapered pockets.

16. The filter bag assembly of claim 12, wherein the substantially rigid mesh is attached upstream portions or downstream portions of adjacent tapered pockets, or the substantially rigid mesh is embedded within the filter material of the primary filter bag, or the substantially rigid mesh is attached to a frame of the primary filter bag.

17. The filter bag assembly of claim 12, further comprising:
a pre-filter bag that includes at least two sidewalls of filter material extending from an open end of the pre-filter bag to a closed end of the pre-filter bag at which the sidewalls connect to close the pre-filter bag, two sidewalls configured to form a tapered pocket, the pre-filter bag including a plurality of tapered pockets; and
wherein the pre-filter bag is configured to nest substantially within the primary filter bag.

18. The filter bag assembly of claim 17, wherein the primary filter bag has a filter efficiency greater than or equal to about 40%, and the pre-filter bag has a filter efficiency less than about 50%; and wherein the primary filter bag is a M5 to F9 class air filter, and the pre-filter is a G1 to M5 class air filter, according to the EN779:2012 standard.

19. The filter bag assembly of claim 12, further comprising:
a mesh reinforcement member configured to support the substantially rigid mesh, so that the substantially rigid mesh will maintain its substantially V-shape.

20. The filter bag assembly of claim 19, wherein the mesh reinforcement member is comprised of at least one of:
a rigid wire, a rigid pole or a rigid member having a cross-sectional I-shape.

21. The filter bag assembly of claim 1, wherein the V-shape of the substantially rigid mesh is formed by a pair of connected, substantially planar wall portions, each wall portion having an outer surface and an inner surface being substantially parallel to the outer surface, the outer surfaces facing away from one another and the inner surfaces facing one another, the outer surfaces forming an outer V-shape and the inner surfaces forming an inner V-shape defining a substantially triangular void between the pair of connected, substantially planar wall portions.

22. The filter bag assembly of claim 21, wherein the substantially rigid mesh is positioned between the first and second tapered pockets on a downstream side of the filter media of the first filter bag.

23. The filter bag assembly of claim 21, wherein the planar wall portions of the rigid mesh are substantially parallel to the adjacent sidewalls of the first and second tapered pockets.

24. The filter bag assembly of claim 12, wherein the V-shape of the substantially rigid mesh is formed by a pair of connected, substantially planar wall portions, each wall portion having an outer surface and an inner surface being substantially parallel to the outer surface, the outer surfaces facing away from one another and the inner surfaces facing one another, the outer surfaces forming an outer V-shape and the inner surfaces forming an inner V-shape defining a substantially triangular void between the pair of connected, substantially planar wall portions.

25. The filter bag assembly of claim 24, wherein the substantially rigid mesh is positioned between the first and second tapered pockets on a downstream side of the filter media of the first filter bag.

26. The filter bag assembly of claim 24, wherein the planar wall portions of the rigid mesh are substantially parallel to the adjacent sidewalls of the first and second tapered pockets.
